(19) United States
(12) Patent Application Publication
(10) Pub. No.: US 2026/0119235 A1
(43) Pub. Date: Apr. 30, 2026

(54) Back-Posting of Sub-Tasks from Accelerator to Main Processor using Cache Stashing

(71) Applicant: NVIDIA CORPORATION, Santa Clara, CA (US)

(72) Inventors: Alon Amid, Haifa (IL); Omer Heymann, Moshav Tzofit (IL); Kaushal Agarwal, Bangalore (IN); Vyas Venkataraman, San Jose, CA (US)

(21) Appl. No.: 18/931,175

(22) Filed: Oct. 30, 2024

(51) Int. Cl. G06F 9/48; G06F 9/30

(52) U.S. Cl. CPC G06F 9/4881; G06F 9/30047; G06F 9/4856

(57) ABSTRACT

A computing system includes a main processor and an accelerator. The main processor includes a cache. The main processor is to assign a computing task to the accelerator. The accelerator is to select a sub-task of the computing task, and to assign the sub-task back to the main processor by stashing the sub-task directly into the cache of the main processor.

### TECHNICAL FIELD

The present disclosure relates generally to computing systems, and particularly to methods and systems for back-posting of sub-tasks using cache stashing.

### BACKGROUND

Some computing systems comprise a host and one or more accelerators that offload computing tasks from the main processor. The host may comprise, for example, a Central Processing Unit (CPU). The accelerators may comprise, for example, Graphics Processing Units (GPUs). Depending on the application and on the type of accelerator, computing tasks that lend themselves to offloading may comprise, for example, Artificial Intelligence (AI) computations, cryptographic computations, matrix operations, and various others.

### SUMMARY

An embodiment that is described herein provides a computing system including a main processor and an accelerator. The main processor includes a cache. The main processor is to assign a computing task to the accelerator. The accelerator is to select a sub-task of the computing task, and to assign the sub-task back to the main processor by stashing the sub-task directly into the cache of the main processor.

In some embodiments, the main processor includes (i) multiple processor cores, (ii) multiple Level-2 (L2) caches associated respectively with the multiple processor cores, and (iii) a System-Level Cache (SLC), and the accelerator is to stash the sub-task directly into one of the L2 caches. In an example embodiment, the accelerator is to choose a processor core among the multiple processor cores for executing the sub-task, and to stash the sub-task into an L2 cache of the chosen processor core.

In alternative embodiments, the main processor includes (i) multiple processor cores, (ii) multiple Level-2 (L2) caches associated respectively with the multiple processor cores, and (iii) a System-Level Cache (SLC), and the accelerator is to stash the sub-task directly into the SLC. In an example embodiment, the main processor is to choose a processor core among the multiple processor cores for executing the sub-task, and the chosen processor core is to retrieve the sub-task from the SLC.

In a disclosed embodiment, the main processor is a Central Processing Unit (CPU) and the accelerator is a Graphics Processing Unit (GPU).

There is additionally provided, in accordance with an embodiment that is described herein, a computing method including assigning a computing task from a main processor to an accelerator. In the accelerator, a sub-task of the computing task is selected, and the sub-task is assigned back to the main processor by stashing the sub-task directly into a cache of the main processor.

The present disclosure will be more fully understood from the following detailed description of the embodiments thereof, taken together with the drawings in which:

### BRIEF DESCRIPTION OF THE DRAWINGS

FIGS. 1 and 2 are block diagrams that schematically illustrate computing systems that perform reverse offloading of sub-tasks from an accelerator to a main processor using cache stashing, in accordance with embodiments that are described herein; and

FIG. 3 is a flow chart that schematically illustrates a computing method including reverse offloading of a sub-task from an accelerator to a main processor using cache stashing, in accordance with an embodiment that is described herein.

### DETAILED DESCRIPTION OF EMBODIMENTS

### Overview

Embodiments that are described herein provide improved techniques for “reverse offloading” of computing sub-tasks from an accelerator back to a main processor. The embodiments described herein refer mainly to a CPU as an example of a main processor, and to a GPU as an example of an accelerator. In some embodiments of reverse offloading a CPU or GPU may be a main processor, and a Data Processing Unit (DPU—also referred to as a “Smart NIC” or network processor) as an accelerator. Other combinations are possible, such as a DPU as a main processor and a GPU as an accelerator. Generally, however, the disclosed techniques are applicable to main processors and accelerators of any other suitable types.

In some embodiments, a main processor assigns a computing task to an accelerator. Upon receiving the task, the accelerator typically partitions the task into sub-tasks and schedules the sub-tasks for execution.

In some cases, however, the accelerator may find that a specific sub-task is best executed by the main processor and not by the accelerator. For example, the main processor may outperform the accelerator in executing sub-tasks that require large memory space or large Input/Output (I/O) bandwidth. As another example, a certain sub-task may require a special acceleration engine that is not available in the accelerator. Any other reason may apply.

Thus, in some scenarios the accelerator may decide to send a certain sub-task back to the main processor for execution. This action is referred to herein as “reverse offloading”. One possible mechanism for reverse offloading is for the accelerator to write a descriptor of the sub-task to a memory that is accessible to the main processor, and then notify the main processor of the pending sub-task.

Reverse offloading of a sub-task is typically required to incur minimal latency. For example, other sub-tasks may depend on the results of the reverse-forwarded sub-task, and cannot begin until the reverse-forwarded sub-task is completed. Much of the reverse-offloading latency is contributed by the time needed for the main processor to retrieve the descriptor of the sub-task from memory, (includes the time needed for the main processor to poll and identify the pending sub-task, and to read and decode the sub-task). Reducing the descriptor retrieval time of the main processor has a considerable effect on the offloading latency.

In some embodiments that are described herein, the accelerator reduces the descriptor retrieval time by writing the descriptor directly into a cache memory of the main processor, rather than to the main system memory. For the main processor, accessing a cache memory is considerably faster than accessing the system memory, and therefore this technique reduces the descriptor retrieval time significantly. Writing the descriptor to a cache memory instead of to the system memory also reduces the write/read bandwidth to/from the main memory, thereby improving the performance of other applications that may compete for access to system memory.

Writing a descriptor directly into a cache memory is also referred to herein as “stashing” the descriptor. For brevity, the term “cache memory” is sometimes referred to simply as “cache”. The terms “stashing a descriptor of a sub-task” and “stashing a sub-task” are used interchangeably.

In a typical configuration, the main processor comprises (i) multiple processor cores and (ii) multiple Level-2 (L2) caches associated respectively with the processor cores. Each L2 cache is accessible only to the corresponding processor core, and is therefore sometimes referred to as a “private L2 cache”. In addition, the processor comprises a System-Level Cache (SLC) that is accessible to all the processor cores.

In some embodiments, the accelerator stashes the sub-task into one of the private L2 caches. This scheme provides very low latency, but on the other hand implies that the accelerator needs to be aware of (or decide on) the identity of the processor core that will execute the reverse-offloaded sub-task. In other embodiments, the accelerator stashes the sub-task into the SLC. This scheme is higher in latency, but in return allows any processor core to access the descriptor. The main processor thus has greater flexibility in scheduling the sub-task.

Stashing information by a GPU to a cache of a CPU is distinctly different from stashing between peer CPUs, and from stashing from a CPU to a GPU. For example, a GPU is typically a software-programmable accelerator, and therefore stashing should typically be exposed to the user. Moreover, a GPU typically has a different programming model from a peer CPU. Therefore, programmable stashing from a GPU to a CPU should typically expose custom-instructions and software Application Programming Interfaces (APIs), or use alternative measures in memory address mapping as part of the translation path.

### System Description

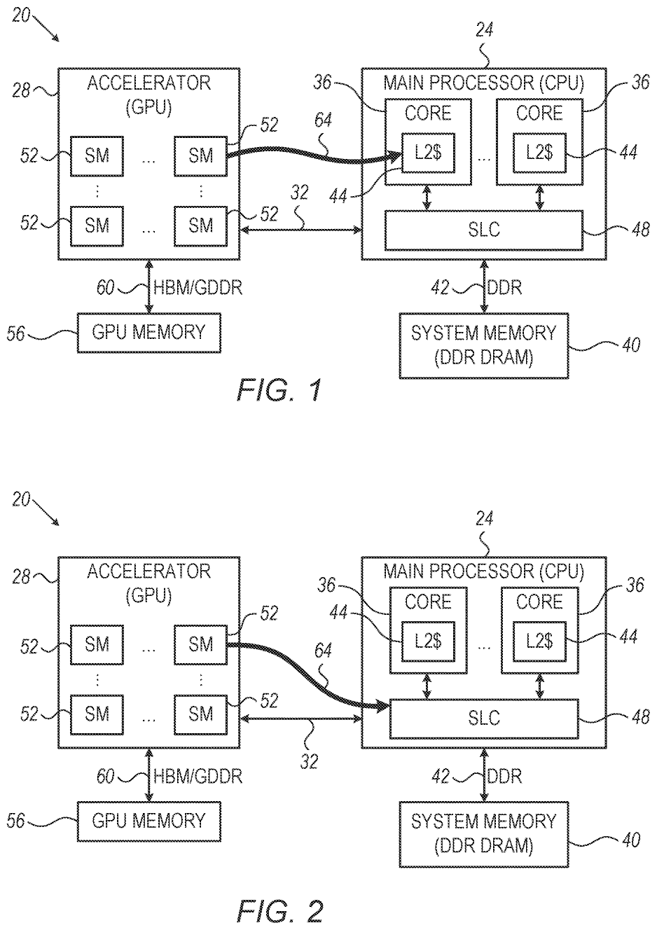

FIG. 1 is a block diagram that schematically illustrates a computing system 20 that performs reverse offloading of sub-tasks from an accelerator to a main processor using cache stashing, in accordance with an embodiment that is described herein. System 20 can be used, for example, to implement a data center, a High-Performance Computing (HPC) cluster, or any other suitable use-case or application.

In the present example, the main processor is a CPU 24 and the accelerator is a GPU 28. CPU 24 and GPU 28 communicate with one another over a suitable link 32, e.g., a Chip-to-Chip (C2C) link, Ground Reference Signaling (GRS) link, Low-power interface (LPI), Low latency interface (LLI), NVLINK, or PCIe link. In some embodiments, the main processor may be a GPU or a CPU, and the accelerator may be a different processor such as a network processor, SmartNIC or DPU). Other combinations of CPU, GPU and DPU are possible, e.g. the CPU and/or the GPU are integrated in a DPU.

CPU 24 comprises multiple processor cores 36. CPU 24 is coupled to a system memory 40 (also referred to as a main memory), in the present example a Dual Data Rate (DDR) Dynamic Random-Access Memory (DRAM) 40. CPU 24 is connected to DRAM 40 by a DDR bus interface 42.

CPU 24 comprises a multi-level cache that comprises (i) Level-2 (L2) caches 44 (denoted “L2$” in the figure), (ii) a System-Level Cache (SLC) 48, and (iii) system memory 40. Each L2 cache 44 is assigned to a respective core 36 and is not accessible to other cores 36. The L2 caches are therefore also referred to as the private caches of the processor cores. SLC 48 is accessible to all cores 36.

The different memories used by cores 36 (system memory 40, L2 caches 44 and SLC 48) differ from one another in size and access latency (access time), as follows:

| Memory type | Size | Access time |
|---|---|---|
| Main memory 40 | Large | Slow |
| SLC 48 | Medium | Medium |
| L2 cache 44 | Small | Fast |

GPU 28 of system 20 comprises multiple processing units referred to as Streaming Multiprocessors (SMs) 52. GPU 28 is coupled to a GPU memory 56, typically a High-Bandwidth Memory (HBM). GPU 28 is connected to GPU memory 56 by a HBM or Graphics DDR (GDDR) bus interface 60.

In a typical mode of operation, CPU 24 assigns computing tasks to GPU 28 for execution. When receiving a given task, GPU 28 partitions the task into sub-tasks and schedules the sub-tasks for execution by SMs 52. In some cases, a certain SM 52 may decide to assign a certain sub-task back to CPU 24.

In the embodiment of FIG. 1, the SM assigns (“reverse offloads”) the sub-task by stashing the descriptor of the sub-task directly into to L2 cache 44 of a certain processor core 36 of CPU 24. The stashing operation is marked with an arrow 64 in FIG. 1. The term “directly” in this context means that SM 52 writes the descriptor into L2 cache 44 without going through system memory 40 or SLC 48.

Stashing the reverse-offloaded sub-task into L2 cache 44 enables core 36 of CPU 24 to retrieve the sub-task descriptors with minimal latency. On the other hand, stashing the sub-task into a particular L2 cache 44 effectively decides that the sub-task will be executed by the processor core 36 corresponding to that Ls cache. This implies that GPU 28 is the entity that decides which core 36 of CPU 24 should execute the sub-task. This scheme degrades the flexibility of CPU 24 in performing load balancing among reverse-offloaded sub-tasks (and between reverse-offloaded sub-tasks and other tasks) on cores 36.

FIG. 2 is a block diagram that schematically illustrates an alternative cache stashing scheme for reverse offloading of sub-tasks in system 20, in accordance with an alternative embodiment that is described herein. In the embodiment of FIG. 2, SM 52 stashes the descriptor of a reverse-offloaded sub-task into SLC 48—As illustrated by arrow 64.

Since SLC 48 is accessible to all processor cores 36, CPU 24 may assign the sub-task to any core 36, in accordance with any suitable criterion or policy. On the other hand, the time needed for core 36 to retrieve the sub-task descriptor from SLC 48 is longer than the retrieval time of the scheme of FIG. 1 above.

The configurations of system 20, CPU 24 and GPU 28, as shown in FIGS. 1 and 2, are example configurations that are chosen purely for the sake of conceptual clarity. In alternative embodiments, any other suitable configurations can be used. For example, the disclosed techniques are not limited to a CPU and a GPU, and may be used with any other suitable type of main processor and any other suitable type of accelerator.

As another example, CPU 24 (or other main processor) may comprise any other suitable cache structure or hierarchy, and GPU 28 (or other accelerator) may stash sub-task descriptors into any other suitable cache. As yet another example, the system may comprise multiple GPUs (or other accelerators) coupled to CPU 24 (or other main processor).

The various elements of system 20 may be implemented in hardware, e.g., in one or more Application-Specific Integrated Circuits (ASICs) or FPGAs, in software, or using a combination of hardware and software elements. Elements that are not necessary for understanding the principles of the present invention have been omitted from the figures for clarity.

CPU 24 and/or GPU 28 may comprise general-purpose processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

Reverse Offloading Using Cache Stashing from GPU to CPU

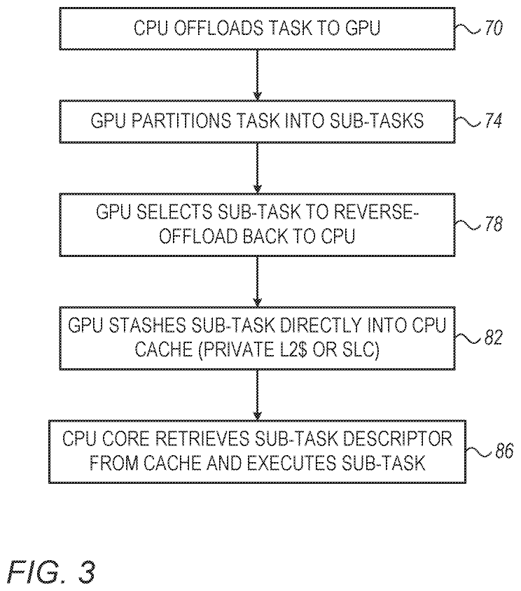

FIG. 3 is a flow chart that schematically illustrates a computing method including reverse offloading of a sub-task from an accelerator to a main processor using cache stashing, in accordance with an embodiment that is described herein.

The method begins with CPU 24 offloading a computing task to GPU 28, at an offloading stage 70. GPU 28 partitions the task into multiple sub-tasks, at a partitioning stage 74. GPU 28 (typically a certain SM 52 in the GPU) selects a certain sub-task for reverse offloading back to CPU 24, at a sub-task selection stage 78.

At a stashing stage 82, GPU 28 stashes a descriptor of the sub-task directly into a cache memory of CPU 24 (e.g., into a L2 cache 44 of a certain core 36, or into SLC 48). A certain core 36 of CPU 24 retrieves the sub-task descriptor from the cache and executes the sub-task in accordance with the descriptor, at a retrieval and execution stage 86. Following execution, CPU 24 typically sends a completion notification to GPU 28 indicating that the reverse-offloaded sub-task has been completed.

The method flow of FIG. 3 is an example flow that is depicted purely for the sake of clarity. In alternative embodiments, any other suitable flow can be used.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A computing system, comprising:
a main processor comprising a cache; and
an accelerator, wherein:
the main processor is to assign a computing task to the accelerator; and
the accelerator is to select a sub-task of the computing task, and to assign the sub-task back to the main processor by stashing the sub-task directly into the cache of the main processor.

2. The system according to claim 1, wherein:
the main processor comprises (i) multiple processor cores, (ii) multiple Level-2 (L2) caches associated respectively with the multiple processor cores, and (iii) a System-Level Cache (SLC); and
the accelerator is to stash the sub-task directly into one of the L2 caches.

3. The system according to claim 2, wherein the accelerator is to choose a processor core among the multiple processor cores for executing the sub-task, and to stash the sub-task into an L2 cache of the chosen processor core.

4. The system according to claim 1, wherein:
the main processor comprises (i) multiple processor cores, (ii) multiple Level-2 (L2) caches associated respectively with the multiple processor cores, and (iii) a System-Level Cache (SLC); and
the accelerator is to stash the sub-task directly into the SLC.

5. The system according to claim 4, wherein the main processor is to choose a processor core among the multiple processor cores for executing the sub-task, and wherein the chosen processor core is to retrieve the sub-task from the SLC.

6. The system according to claim 1, wherein the main processor is a Central Processing Unit (CPU) and the accelerator is a Graphics Processing Unit (GPU).

7. A computing method, comprising:
assigning a computing task from a main processor to an accelerator; and
in the accelerator, selecting a sub-task of the computing task, and assigning the sub-task back to the main processor by stashing the sub-task directly into a cache of the main processor.

8. The method according to claim 7, wherein:
the main processor comprises (i) multiple processor cores, (ii) multiple Level-2 (L2) caches associated respectively with the multiple processor cores, and (iii) a System-Level Cache (SLC); and
stashing the sub-task comprises writing the sub-task directly into one of the L2 caches.

9. The method according to claim 8, wherein stashing the sub-task comprises, in the accelerator, choosing a processor core among the multiple processor cores for executing the sub-task, and stashing the sub-task into an L2 cache of the chosen processor core.

10. The method according to claim 7, wherein:
the main processor comprises (i) multiple processor cores, (ii) multiple Level-2 (L2) caches associated respectively with the multiple processor cores, and (iii) a System-Level Cache (SLC); and
stashing the sub-task comprises writing the sub-task directly into the SLC.

11. The method according to claim 10, further comprising:
choosing, by the main processor, a processor core among the multiple processor cores for executing the sub-task; and
retrieving the sub-task from the SLC by the chosen processor core.

12. The method according to claim 7, wherein the main processor is a Central Processing Unit (CPU) and the accelerator is a Graphics Processing Unit (GPU).
